(19) United States
(12) Patent Application Publication
(10) Pub. No.: US 2006/0116790 A1
(43) Pub. Date: Jun. 1, 2006

(54) Apparatus for monitoring air conditioner

(75) Inventors: Baik-young Chung, Incheon (KR); Ki-bum Kim, Seoul (KR); Ho-jong Jeong, Seoul (KR); Si-kyong Sung, Seoul (KR); Jae-sik Kang, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/285,308

(22) Filed: Nov. 23, 2005

(30) Foreign Application Priority Data
Nov. 26, 2004 (KR) 10-2004-0098130

(51) Int. Cl. G05D 23/00

(52) U.S. Cl. 700/276; 236/51

(57) ABSTRACT

An apparatus for monitoring an air conditioner is disclosed. The apparatus includes a first wireless device connected to the air conditioner, and a second wireless device connected to a monitoring terminal. The first wireless device transmits and receives monitoring result information and monitoring-related information based on a monitoring program installed in the monitoring terminal in a local-area wireless communication manner, and the second wireless device transmits and receives the monitoring-related information and monitoring result information based on the monitoring program in the local-area wireless communication manner. Therefore, local-area wireless communication can be carried out between the air conditioner and the monitoring terminal, thereby making it possible to significantly save trouble for installation of monitoring instruments, such as cables and a converter, and to significantly curtail costs and manpower for monitoring work.

### BACKGROUND OF THE INVENTION

1. Field of the Invention

The present invention relates to an air conditioner, and more particularly to a technique for monitoring the status of an air conditioner.

2. Description of the Related Art

An air conditioner generally refers to an appliance that cools or heats an indoor space such as a residential area, restaurant or office. Recently, in order to more efficiently cool or heat an indoor space partitioned into a plurality of rooms, a technique has been developed which cools or heats the rooms individually using one air conditioner.

In general terms, air conditioners may be classified into a separated type wherein indoor and outdoor units are separated from each other, and an integrated type wherein indoor and outdoor units are integrated. Air conditioners may also be classified into a single type wherein one indoor unit is connected to one outdoor unit, and a multi-type wherein a plurality of indoor units installed respectively in rooms are connected in common to one outdoor unit via a network.

Meanwhile, it may sometimes be necessary to monitor the status of an air conditioner. For example, an installer, constructor, manager or the like (generically referred to hereinafter as the “manager”) may monitor the status of an air conditioner upon installation of the air conditioner or periodically for maintenance thereof.

A description will hereinafter be given of a problem with a conventional system for monitoring the status of an air conditioner with reference to FIG. 1. It is assumed here that the air conditioner is of the separated type and the multi-type for the purpose of a better understanding of the conventional problem.

For smooth testing or maintenance of the air conditioner, the manager has to accurately recognize information of outdoor and indoor units of the air conditioner. In the conventional monitoring system, a personal computer (PC) processes and displays the information of the outdoor unit of the air conditioner, denoted by reference numeral 101, using serial communication.

That is, in the conventional monitoring system, in order to determine whether the outdoor and indoor units of the air conditioner are normal or abnormal, the manager dismantles the front panel of the outdoor unit 101 from the body thereof and then the cover of a circuit box in the outdoor unit 101 from the body of the circuit box. Subsequently, the manager connects one plug of a jig cable 103 to an operation/monitoring control unit in the circuit box (not shown). The jig cable 103 connected to the outdoor unit 101 is generally 15 to 20M long.

The air conditioner may support any communication protocols. For example, the air conditioner may support RS-485 communication protocol. In this case, an RS-485 communication port may be provided in the operation/monitoring control unit or separately from the control unit.

A monitoring terminal 109 may be a general PC terminal which can be carried by the manager, such as a notebook computer. The monitoring terminal 109 is connected with a monitor of the operation/monitoring control unit in the outdoor unit 101 to communicate therewith. That is, the monitoring terminal 109 runs a monitoring program to communicate with the monitor to transmit monitoring-related information to the monitor and receive monitoring result information from the monitor.

Similarly, the monitoring terminal 109 may support any communication protocols for communications with other external devices. For example, such communication protocols may be a serial communication protocol and universal serial bus (USB) protocol. Communication protocols supported by the air conditioner and the monitoring terminal 109 may often be different from each other.

A converter 105 is connected with the other plug of the jig cable 103 and in turn with one plug of a cable 107 (e.g., a serial cable or USB to serial conversion cable) for the monitoring terminal 109. The converter 105 is adapted to convert monitoring result information of the air conditioner into that of a communication protocol of the monitoring terminal, and monitoring-related information of the monitoring terminal into that of a communication protocol of the air conditioner, respectively.

The above-mentioned conventional monitoring system is disadvantageous in that, in order to monitor the status of the air conditioner, the manager has the inconvenience of having to move with the jig cable 103 to a place where the outdoor unit 101 is present, dismantle the front panel of the outdoor unit 101 from the body thereof and then the cover of the circuit box from the body thereof, and then connect the jig cable 103 to the operation/monitoring control unit. Further, a plurality of instruments which are too heavy and complex to install, such as the cables 103 and 107 and the converter 105, must be provided in the conventional monitoring system, and much trouble is required to install those instruments.

In addition, the conventional monitoring system encounters restrictions in the lengths of the jig cable 103 and serial cable 107. For this reason, for example, in the case where the outdoor unit and the indoor units are far away from each other, monitoring result information may become unstable due to a limitation in communication distances between the outdoor unit and the indoor units. To solve this problem, the manager has to go outdoors to perform monitoring, which leads to inconvenience of use.

### SUMMARY OF THE INVENTION

Therefore, the present invention has been made in view of the above problems, and it is an object of the present invention to provide an improved technique for monitoring the status of an air conditioner.

It is another object of the present invention to provide an apparatus for monitoring the status of an air conditioner, wherein costs and manpower for installation of monitoring instruments can be curtailed.

It is a further object of the present invention to provide an apparatus for monitoring the status of an air conditioner, wherein the statuses of outdoor and indoor units can be monitored indoors.

It is yet another object of the present invention to provide an apparatus for monitoring the status of an air conditioner, wherein reliability of monitoring result information being transmitted can be secured.

In accordance with the present invention, the above and other objects can be accomplished by the provision of an apparatus for monitoring an air conditioner, comprising: a first wireless device connected to the air conditioner, the first wireless device transmitting and receiving monitoring result information and monitoring-related information based on a monitoring program installed in a monitoring terminal in a local-area wireless communication manner; and a second wireless device connected to the monitoring terminal, the second wireless device transmitting and receiving the monitoring-related information and monitoring result information based on the monitoring program in the local-area wireless communication manner.

Preferably, the first wireless device includes: a connector connected to a connector of an operation/monitoring control unit provided in the air conditioner; and a local-area wireless communication unit for receiving the monitoring result information from the operation/monitoring control unit through the connector of the first wireless device, transmitting the received monitoring result information to the second wireless device in the local-area wireless communication manner, receiving the monitoring-related information from the second wireless device in the local-area wireless communication manner, and delivering the received monitoring-related information to the operation/monitoring control unit through the connector of the first wireless device.

Preferably, the second wireless device includes: a connector connected to a connector of the monitoring terminal; and a local-area wireless communication unit for receiving the monitoring result information transmitted from the first wireless device in the local-area wireless communication manner, delivering the received monitoring result information to the monitoring terminal through the connector of the second wireless device, receiving the monitoring-related information from the monitoring terminal through the connector of the second wireless device, and transmitting the received monitoring-related information to the first wireless device in the local-area wireless communication manner.

The first wireless device may further include a converter for converting the monitoring result information from the operation/monitoring control unit, received through the connector of the first wireless device, into that of a communication protocol of the monitoring terminal, and the monitoring-related information from the second wireless device, received in the local-area wireless communication manner, into that of a communication protocol of the air conditioner, respectively.

In a feature of the present invention, local-area wireless communication can be carried out between an air conditioner and a monitoring terminal using a pair of wireless devices that can be simply and conveniently carried and installed. Therefore, it is possible to significantly save trouble for installation of monitoring instruments, such as cables and a converter, and to significantly curtail costs and manpower for monitoring work.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view of a conventional system for monitoring the status of an air conditioner;

FIG. 2 is a schematic view of a system for monitoring the status of an air conditioner according to the present invention;

FIG. 3 is a block diagram showing the configuration of an apparatus for monitoring the status of an air conditioner according to an exemplary embodiment of the present invention; and

FIG. 4 is a block diagram of wireless devices according to an exemplary embodiment of the present invention.

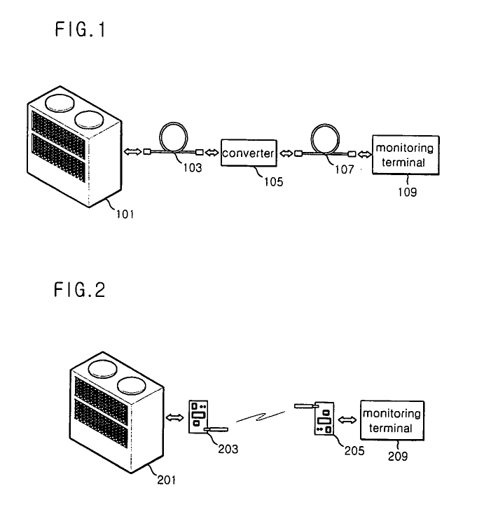

### DESCRIPTION OF THE PREFERRED EMBODIMENTS

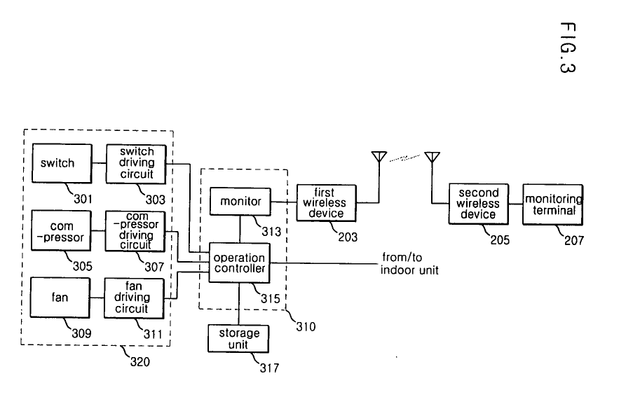

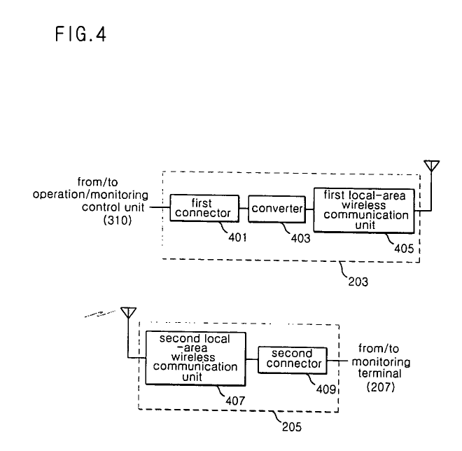

FIG. 2 is a schematic view of a system for monitoring the status of an air conditioner according to the present invention, FIG. 3 is a block diagram showing the configuration of an apparatus for monitoring the status of an air conditioner according to an exemplary embodiment of the present invention, and FIG. 4 is a block diagram of wireless devices according to an exemplary embodiment of the present invention. The preferred embodiments of the present invention will hereinafter be described with reference to these figures.

With reference to FIG. 3, an operation/monitoring control unit 310 is provided in an outdoor unit 201 of the air conditioner. The operation/monitoring control unit 310 includes an operation controller 315 for controlling the operation of a driving part 320 of the air conditioner according to an operating program stored in a storage unit 317. For example, the operation controller 315 controls the flow of refrigerant according to a cooling mode or heating mode. As well known to those skilled in the art, the air conditioner is operated in the cooling mode or heating mode depending on which one of outdoor and indoor heat exchangers (not shown) into which high-temperature, high-pressure refrigerant discharged from a compressor 305 is introduced earlier.

The control operation of the operation controller 315 and the operation of the driving part 320 of the air conditioner are well known in the art. For reference, the operation of the operation controller 315 will hereinafter be described in conjunction with a few examples. A compressor driving circuit 307 drives the compressor 305 under the control of the operation controller 315 such that the compressor 305 discharges high-temperature, high-pressure refrigerant. At this time, the operation controller 315 computes an appropriate operating frequency of the compressor 305 on the basis of a set target temperature and a room temperature.

A switch 301 is provided in a pipe arrangement (not shown and may be positioned at the side of the outdoor unit) to switch the flow of the refrigerant. At this time, the operation controller 315 outputs an associated control signal to a switch driving circuit 303 such that the switch driving circuit 303 drives the switch 301. A fan 309 blows air to raise heat exchange efficiency. To this end, the operation controller 315 controls a fan driving circuit 311 to drive the fan 309.

The operation/monitoring control unit 310 further includes a monitor 313 for monitoring the status of the air conditioner according to a monitoring program and transmitting monitoring result information (for example, pressure information, temperature information, and operation information such as the presence or absence of an error in each unit) to a monitoring terminal 207. The operation of this monitor 313 is well known in the art. Those skilled in the art will readily embody the monitor 313 from this specification.

In one embodiment, the monitor 313 stores the operating frequency of the compressor 305 in the storage unit 317 and transmits it to the monitoring terminal 207. The monitor 313 also detects the room temperature or the temperature of the pipe arrangement, stores the detected temperature in the storage unit 317 and transmits it to the monitoring terminal 207. In addition, the monitor 313 checks the switching state of the switch 301, stores the check result in the storage unit 317 and transmits it to the monitoring terminal 207.

Preferably, for the monitoring of the status of the air conditioner, a first wireless device 203 is connected to the outdoor unit 201 of the air conditioner and a second wireless device 205 is connected to the monitoring terminal 207, as shown in FIGS. 2 and 3.

With reference to FIG. 4, the first wireless device 203, connected to the outdoor unit 201 of the air conditioner, includes a first connector 401 connected to an associated connector (not shown) of the operation/monitoring control unit 310 in the outdoor unit 201, and a first local-area wireless communication unit 405 for receiving monitoring result information based on the monitoring program from the monitor 313 of the operation/monitoring control unit 310 through the first connector 401, transmitting the received monitoring result information to the monitoring terminal 207 in a local-area wireless communication manner, receiving monitoring-related information based on the monitoring program from the monitoring terminal 207 in the local-area wireless communication manner, and delivering the received monitoring-related information to the monitor 313 through the first connector 401. The second wireless device 205, connected to the monitoring terminal 207 in which the monitoring program is run, includes a second connector 409 inserted into a connection terminal of the monitoring terminal 207, and a second local-area wireless communication unit 407 for receiving the monitoring result information transmitted from the first local-area wireless communication unit 405 in the local-area wireless communication manner, delivering the received monitoring result information to the monitoring terminal 207 through the second connector 409, receiving the monitoring-related information based on the monitoring program from the monitoring terminal 207 through the second connector 409, and transmitting the received monitoring-related information to the first local-area wireless communication unit 405 in the local-area wireless communication manner.

As stated above, the first wireless device 203 is connected to the outdoor unit 201 of the air conditioner. The first connector 401 is provided in the first wireless device 203 and connected to an associated connector of the operation/monitoring control unit 310 in the outdoor unit 201. The air conditioner may support any communication protocols. Preferably, the air conditioner supports RS-485 communication protocol.

In this case, an RS-485 communication port may be provided in the operation/monitoring control unit 310 or separately from the control unit 310. Once a communication port is provided separately from the operation/monitoring control unit 310, the first connector 401 is connected to the control unit 310 via the provided communication port.

A protocol conversion operation must be additionally performed with respect to data to be transmitted through a communication port, for example, an RS-485 communication port. It will be understood herein that the first connector 401 is connected to the operation/monitoring control unit 310 through a communication port which is provided in the operation/monitoring control unit 310 or separately from the control unit 310.

For example, the first connector 401 may be fitted in an associated connector (not shown), for example, a card slot, receptacle or the like, of the operation/monitoring control unit 310. Namely, the first wireless device 203 may be made in the form of a card or module, so that it can be mounted to the associated connector of the control unit 310. As a result, the first connector 401 may be made in the form of a terminal fittable in a card slot or in the form of a plug insertable into a receptacle.

A technology that mounts a computer peripheral product in card or module form on a main printed circuit board of a computer or a housing of a main device of the computer is well known in a computer system manufacturing field. Those skilled in the art will readily embody the first connector 401 and the associated connector of the control unit 310 from this specification.

The second wireless device 205 is connected to the monitoring terminal 205. The second connector 409 of the second wireless device 205 is preferably a USB connector, which may be a USB plug or USB receptacle. The USB connector is connected to the monitoring terminal 207, such as a computer, directly or via a USB cable.

The first local-area wireless communication unit 405 of the first wireless device 203 and the second local-area wireless communication unit 407 of the second wireless device 205 perform local-area wireless communication with each other.

In one embodiment, each of the first and second local-area wireless communication units 405 and 407 is implemented with a USB Bluetooth module. The USB Bluetooth module is a device that is connected to a USB host. (through a USB connector) to support USB communication, and wirelessly transmits and receives data in a Bluetooth communication manner. Those skilled in the art will readily embody such a USB Bluetooth module from this specification.

The USB Bluetooth module generally includes a USB Bluetooth module controller, and a Bluetooth wireless processor. The Bluetooth module controller includes a high-speed processing module, an interface module for the Bluetooth wireless processor, a Bluetooth baseband processing module, and a universal input/output unit. The Bluetooth module controller provides a USB device communication function to perform the USB communication with the USB host. It also processes a local-area wireless data communication function with other USB Bluetooth modules.

Preferably, the first wireless device 203 further includes a converter 403 for converting the monitoring result information from the monitor 313 of the operation/monitoring control unit 310, received through the first connector 401, into that of a communication protocol of the monitoring terminal 207, and the monitoring-related information from the monitoring terminal 207, delivered by the first local-area wireless communication unit 405, into that of a communication protocol of the air conditioner, respectively.

Communication protocols supported by the air conditioner and the monitoring terminal 207 may often be different from each other. In this connection, the converter 403 is adapted to convert the monitoring result information of the air conditioner into that of the communication protocol of the monitoring terminal 207, and the monitoring-related information of the monitoring terminal 207 into that of the communication protocol of the air conditioner, respectively. In one embodiment, the communication protocol of the air conditioner is RS-485 communication protocol and the communication protocol of the monitoring terminal 207 is RS-485 communication protocol or USB protocol. As an alternative, the converter 403 may be provided in the air conditioner.

As stated above, the operation/monitoring control unit 310 of the air conditioner has a connector to which the first wireless device 203 is connectable. In one embodiment, the first wireless device 203 is installed in the air conditioner only during monitoring work. In some cases, the wireless device 203 may be installed in the air conditioner even at normal times.

The present invention is also applicable to the case where the air conditioner is of a multi-type wherein a plurality of indoor units installed respectively in rooms are connected in common to one outdoor unit via a network. In one embodiment, the operation/monitoring control unit 310 is connected to one or more indoor units via the network. In this case, the control unit 310 can communicate with an associated indoor unit via an RS-485 communication port (not shown) provided therein or separately therefrom, as described above.

Preferably, the monitoring terminal 207 is a portable terminal (e.g., a notebook computer), so that monitoring instruments can be installed more simply and conveniently.

As apparent from the above description, according to the present invention, local-area wireless communication can be carried out between an air conditioner and a monitoring terminal, thereby making it possible to significantly save trouble for installation of monitoring instruments, such as cables and a converter, and to significantly curtail costs and manpower for monitoring work.

Further, the manager can conveniently perform monitoring even indoors. In addition, because information is transmitted in a local-area wireless communication manner, it is possible to prevent the information from being lost due to a voltage drop of a jig cable, and thus to secure reliability of the information.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for monitoring an air conditioner, comprising:
a first wireless device connected to the air conditioner, the first wireless device transmitting and receiving monitoring result information and monitoring-related information based on a monitoring program installed in a monitoring terminal in a local-area wireless communication manner; and
a second wireless device connected to the monitoring terminal, the second wireless device transmitting and receiving the monitoring-related information and monitoring result information based on the monitoring program in the local-area wireless communication manner.

2. The apparatus as set forth in claim 1, wherein the first wireless device includes:
a connector connected to a connector of an operation/monitoring control unit provided in the air conditioner; and
a local-area wireless communication unit for receiving the monitoring result information from the operation/monitoring control unit through the connector of the first wireless device, transmitting the received monitoring result information to the second wireless device in the local-area wireless communication manner, receiving the monitoring-related information from the second wireless device in the local-area wireless communication manner, and delivering the received monitoring-related information to the operation/monitoring control unit through the connector of the first wireless device.

3. The apparatus as set forth in claim 2, wherein the first wireless device further includes a converter for converting the monitoring result information from the operation/monitoring control unit, received through the connector of the first wireless device, into that of a communication protocol of the monitoring terminal, and the monitoring-related information from the second wireless device, received in the local-area wireless communication manner, into that of a communication protocol of the air conditioner, respectively.

4. The apparatus as set forth in claim 2, wherein the local-area wireless communication unit is a universal serial bus (USB) Bluetooth module.

5. The apparatus as set forth in claim 1, wherein the second wireless device includes:
a connector connected to a connector of the monitoring terminal; and
a local-area wireless communication unit for receiving the monitoring result information transmitted from the first wireless device in the local-area wireless communication manner, delivering the received monitoring result information to the monitoring terminal through the connector of the second wireless device, receiving the monitoring-related information from the monitoring terminal through the connector of the second wireless device, and transmitting the received monitoring-related information to the first wireless device in the local-area wireless communication manner.

6. The apparatus as set forth in claim 5, wherein the local-area wireless communication unit is a USB Bluetooth module.

7. The apparatus as set forth in claim 5, wherein the connector of the second wireless device is a USB connector.

8. The apparatus as set forth in claim 2, wherein:
the air conditioner is of a separated type wherein indoor and outdoor units are separated from each other; and
the operation/monitoring control unit is provided in the outdoor unit.

9. The apparatus as set forth in claim 1, wherein the monitoring terminal is a portable terminal.

10. An apparatus for monitoring an air conditioner, comprising:
an operation/monitoring control unit for controlling driving of the air conditioner and monitoring a driven state of the air conditioner;
a first wireless device connected to the operation/monitoring control unit;
a monitoring terminal equipped with a monitoring program for monitoring the driven state of the air conditioner; and
a second wireless device connected to the monitoring terminal,
wherein the first wireless device transmits and receives monitoring result information and monitoring-related information based on the monitoring program in a local-area wireless communication manner, and the second wireless device transmits and receives the monitoring-related information and monitoring result information based on the monitoring program in the local-area wireless communication manner.

11. The apparatus as set forth in claim 10, wherein:
the air conditioner is of a separated type wherein indoor and outdoor units are separated from each other; and
the operation/monitoring control unit is provided in the outdoor unit.

12. The apparatus as set forth in claim 10, wherein each of the first and second wireless devices includes a local-area wireless communication unit for performing local-area wireless communication,
wherein the local-area wireless communication unit is a USB Bluetooth module.

13. The apparatus as set forth in claim 10, wherein the first wireless device includes a converter for converting the monitoring result information, delivered from the operation/monitoring control unit, into that of a communication protocol of the monitoring terminal, and the monitoring-related information, received from the second wireless device in the local-area wireless communication manner, into that of a communication protocol of the air conditioner, respectively.

14. The apparatus as set forth in claim 10, wherein the monitoring terminal is a portable terminal.

15. An apparatus for monitoring an air conditioner, comprising:
a first wireless device for the air conditioner, the first wireless device including:
a first connector connected to a connector of an operation/monitoring control unit provided in the air conditioner; and
a first local-area wireless communication unit for receiving monitoring result information from the operation/monitoring control unit through the first connector, transmitting the received monitoring result information to a monitoring terminal in a local-area wireless communication manner, receiving monitoring-related information from the monitoring terminal in the local-area wireless communication manner, and delivering the received monitoring-related information to the operation/monitoring control unit through the first connector; and
a second wireless device for the monitoring terminal, the second wireless device including:
a second connector connected to a connector of the monitoring terminal; and
a second local-area wireless communication unit for receiving the monitoring result information transmitted from the first wireless device in the local-area wireless communication manner, delivering the received monitoring result information to the monitoring terminal through the second connector, receiving the monitoring-related information from the monitoring terminal through the second connector, and transmitting the received monitoring-related information to the first wireless device in the local-area wireless communication manner.

16. The apparatus as set forth in claim 15, wherein the first wireless device further includes a converter for converting the monitoring result information from the operation/monitoring control unit into that of a communication protocol of the monitoring terminal, and the monitoring-related information from the second wireless device, received in the local-area wireless communication manner, into that of a communication protocol of the air conditioner, respectively.

17. The apparatus as set forth in claim 15, wherein each of the first local-area wireless communication unit and second local-area wireless communication unit is a USB Bluetooth module.

18. The apparatus as set forth in claim 15, wherein the second connector is a USB connector.

19. The apparatus as set forth in claim 15, wherein:
the air conditioner is of a separated type wherein indoor and outdoor units are separated from each other; and
the operation/monitoring control unit is provided in the outdoor unit.

20. The apparatus as set forth in claim 15, wherein the monitoring terminal is a portable terminal.
